(19) United States
(12) Patent Application Publication
(10) Pub. No.: US 2014/0306666 A1
(43) Pub. Date: Oct. 16, 2014

(54) Apparatus and Method for Battery Balancing

(71) Applicant: SK Innovation Co., Ltd., Seoul (KR)

(72) Inventors: Geun Young Choi, Daejeon (KR); Sang Ho Kim, Daejeon (KR); Woo Seok Song, Daejeon (KR); Jun Ho Kim, Daejeon (KR); Jee Hoon Jeon, Daejeon (KR); Se Hun Jeong, Daejeon (KR); Hyun Seok Kim, Daejeon (KR); Sang Hyuk Park, Daejeon (KR); Jae Geun Jeon, Daejeon (KR); Woo Jin Lee, Daejeon (KR); Jai Hyun Choi, Daejeon (KR); Wook Ho Shin, Daejeon (KR); Se Ho Park, Daejeon (KR)

(73) Assignee: SK Innovation Co., Ltd., Seoul (KR)

(21) Appl. No.: 14/248,864

(22) Filed: Apr. 9, 2014

(30) Foreign Application Priority Data
Apr. 11, 2013 (KR) 10-2013-0039709

(51) Int. Cl. H02J 7/00

(52) U.S. Cl. CPC H02J 7/0014
USPC 320/134

(57) ABSTRACT

Provided are an apparatus and a method for battery balancing, and more particularly, an apparatus and a method for battery balancing capable of implementing balancing between batteries which are connected in parallel by controlling a power relay assembly.

### TECHNICAL FIELD

The present invention relates to an apparatus and a method for battery balancing, and more particularly, to an apparatus and a method for battery balancing capable of implementing balancing between batteries which are connected in parallel by controlling a power relay assembly.

### BACKGROUND

Generally, an energy storage system, an electric vehicle and the like require a chargeable electricity storage system, in which the electricity storage system includes a plurality of batteries. Each battery has a deviation in capacitance which occurs due to several reasons such as a process for manufacturing a battery.

The battery may be configured and used in a larger form of batteries, such as battery unit cells in a minimum unit, battery modules manufactured in one module form in which the plurality of battery unit cells are connected to each other, battery trays manufactured in a tray form in which the plurality of battery modules are connected to each other, and battery banks manufactured in a larger form by connecting the plurality of battery trays to each other, as needed and may be assigned with various names, but these batteries have the same basic function to store electricity. Further, these batteries may be connected in series, in parallel, or in a serial and parallel mixing structure.

Generally, the electricity storage system in which the batteries are connected in series, in parallel, or in a serial and parallel mixing structure has a voltage unbalance due to different electrochemical characteristics between the respective batteries configuring the electricity storage system.

Therefore, a deviation occurs in charging and discharging voltages of each battery during a charging and discharging cycle of the batteries. Therefore, a specific battery may be overcharged while the battery is charged and a specific battery may also be over discharged while the battery is discharged. As described above, the overcharging or the over discharging of the specific battery among the batteries is a cause which may reduce performance of the battery, deteriorate the battery, and reduce the lifespan of the battery.

Therefore, the battery balancing to control the difference between voltages of each of the plurality of cells in the battery to be in a tolerance or the voltages of the plurality of cells to be equal is important and therefore research into a balancing circuit using a voltage and a state of charge (SOC) to remove the voltage unbalance has been prevalently conducted.

US Patent Application Publication No. US-2011-0025258 discloses a system for scheduling charging and discharging of a battery.

### RELATED ART DOCUMENT

### Patent Document

US Patent Application Publication [US-2011-0025258]

### SUMMARY

An exemplary embodiment of the present invention is directed to providing an apparatus and a method for battery balancing by controlling a power relay assembly when a voltage unbalance between batteries connected in parallel occurs.

In one general aspect, there is provided an apparatus for battery balancing, including: a plurality of batteries including positive terminals and negative terminals; a plurality of power relay assemblies including precharge resistors, a plurality of relays, input terminals, and output terminals and electrically connecting or disconnecting the input terminals to or from the output terminals, the input terminals being connected to the positive terminals and the negative terminals of the batteries; and a manager connected to each of the batteries and the power relay assemblies, monitoring a state of each of the batteries, and determining a balancing mode at the time of the occurrence of the battery of which the voltage unbalance is sensed to control the power relay assembly, wherein the output terminals of the power relay assemblies are connected in parallel.

The power relay assembly may include: an input terminal including a positive input terminal connected to the positive terminal of the battery and a negative input terminal connected to the negative terminal of the battery; an output terminal including a positive output terminal connected to the outside and a negative output terminal connected to the outside; a first main relay connected to the positive terminal of the battery in series and cutting off a current applied from the battery; a second main relay connected to the negative terminal of the battery in series and cutting off a current applied from the battery; and a precharge unit connected to the first main relay or the second main relay in parallel and including a precharge resistor and a precharge relay, wherein the precharge resistor and the precharge relay are connected in series.

The precharge resistor may be a variable resistor and a resistance value thereof may be controlled by the manager.

When the voltage of the battery does not belong to a predetermined balance determination range, the manager may determine the battery as a battery of which the voltage unbalance occurs.

The balancing mode of the manager may determine a battery to be balanced including some of the batteries of which the voltage unbalance is sensed.

The balancing mode of the manager may determine a resistance value of the precharge resistor.

In another general aspect, there is provided a method for battery balancing using an apparatus for battery balancing including a battery, a power relay assembly, and a manager, the method including: monitoring, by the manager, voltages of each battery in real time; determining, by the manager, an unbalance of the voltages of each battery monitored in the monitoring; determining, by the manager, a balancing mode when the battery determined as the voltage unbalance in the determining of the unbalance occurs; and controlling, by the manager, the power relay assembly depending on the balancing mode determined in the determining of the balancing mode.

In the determining of the unbalancing, when the voltages of the batteries connected in parallel do not belong to an unbalance determination range, the manager may determine the battery as a battery of which the voltage unbalance occurs.

The determining of the balancing mode may include determining a balancing object determining a battery to be charged and a battery to be discharged in the highest efficiency side by comparing predetermined references.

The determining of the balancing mode may include determining a resistance value of a precharge resistor in the highest efficiency side by comparing predetermined references.

The predetermined references in the determining of the balancing mode may be selected from any one of lifespan, output, and time of the battery.

The controlling of the balancing may include connecting a precharge relay of a power relay assembly connected to a battery to be charged and a battery to be discharged determined in the determining of the balancing object to a contact between a first main relay or a second main relay corresponding to the precharge relay.

The controlling of the balancing may include controlling a resistance value of the precharge resistor 251 with a resistance value determined in the determining of the resistance value (S32).

### BRIEF DESCRIPTION OF THE DRAWINGS

FIG. 1 is a block diagram of an apparatus for battery balancing according to an exemplary embodiment of the present invention.

FIG. 2 is an exemplified diagram of a power relay assembly of an apparatus for battery balancing according to an exemplary embodiment of the present invention.

FIGS. 3 to 7 are flow charts of a method for battery balancing according to an exemplary embodiment of the present invention.

### DETAILED DESCRIPTION OF EMBODIMENTS

Hereinafter, an apparatus for battery balancing and a management method thereof according to an exemplary embodiment of the present invention will be described in detail with reference to the accompanying drawings.

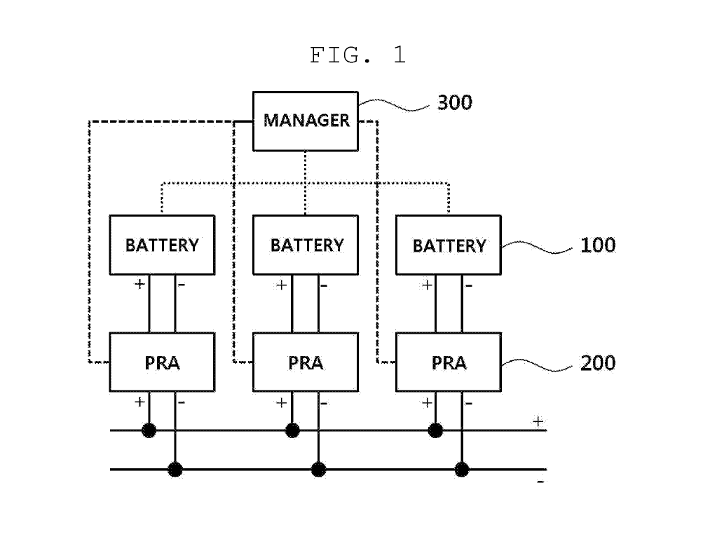

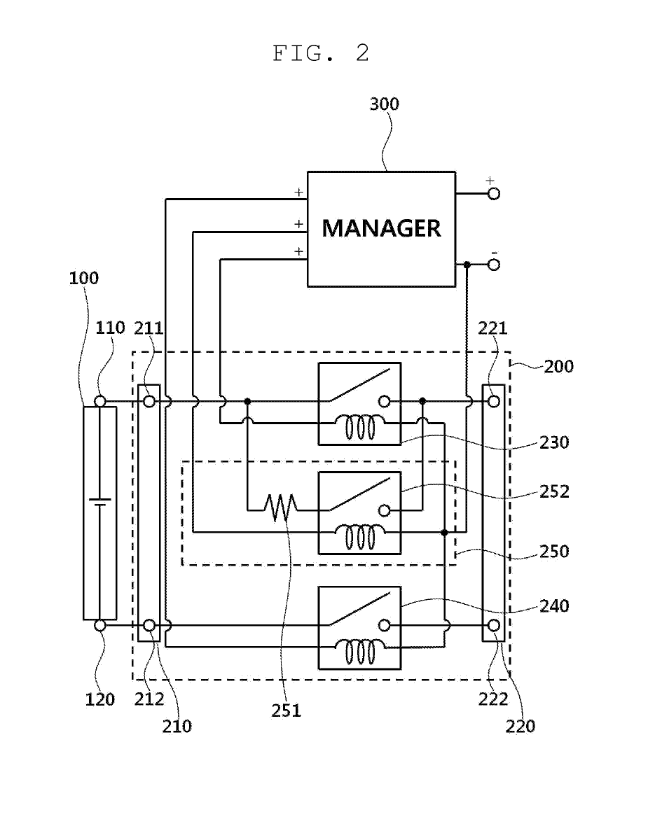

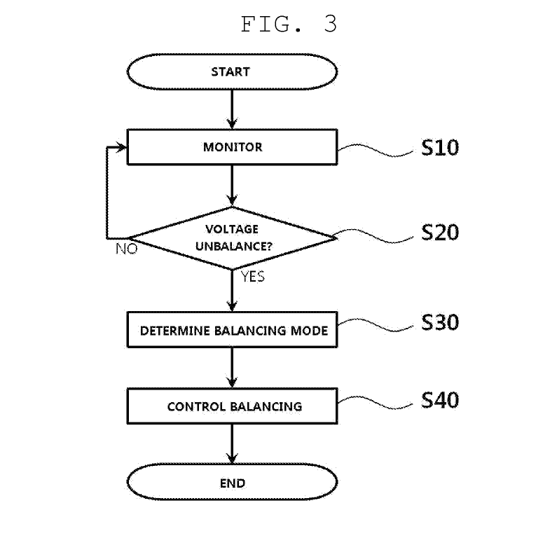

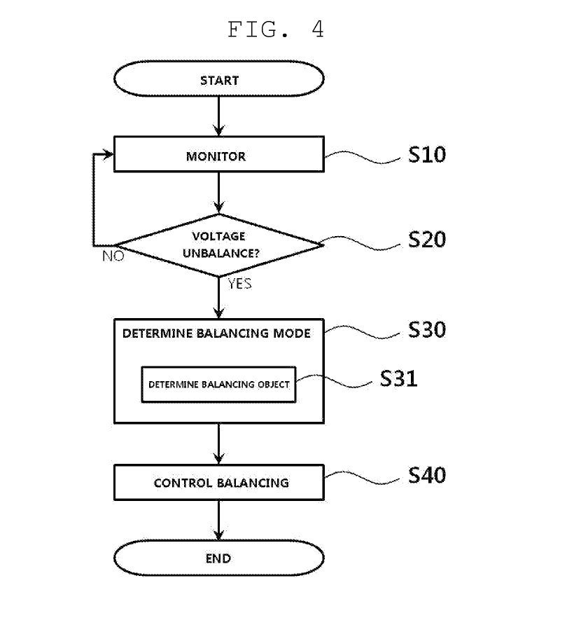

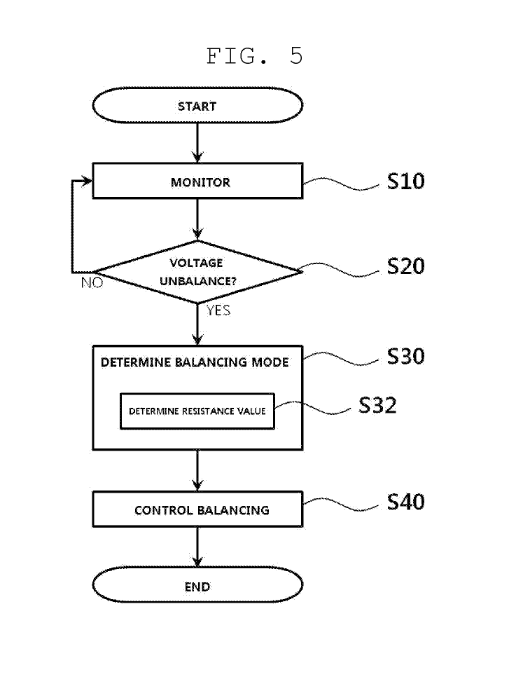

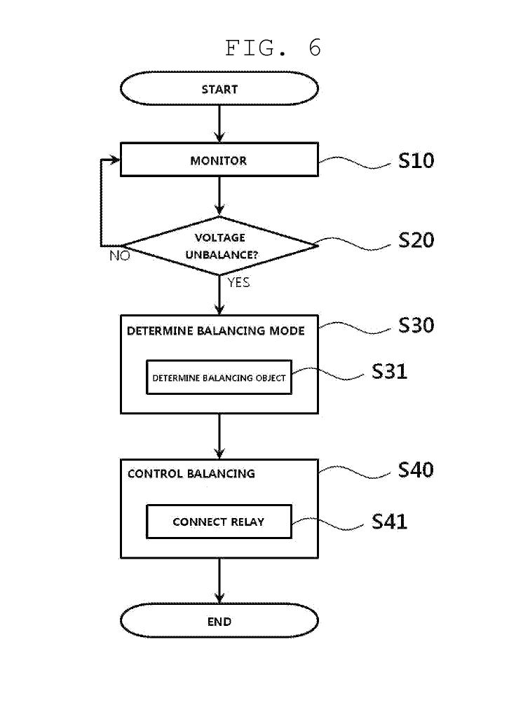

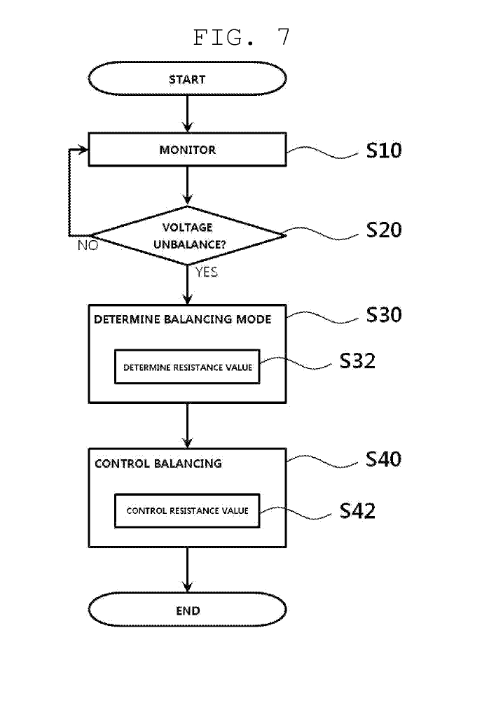

FIG. 1 is a block diagram of an apparatus for battery balancing according to an exemplary embodiment of the present invention, FIG. 2 is an exemplified diagram of a power relay assembly of an apparatus for battery balancing according to an exemplary embodiment of the present invention, and FIGS. 3 to 7 are flow charts of a method for battery balancing according to an exemplary embodiment of the present invention.

A smart grid means a next-generation intelligent power network which uses an advanced information communication technology (ICT) to exchange real-time information between a power supplier and a consumer in two ways so as to optimize energy efficiency. That is, the smart grid is to increase efficiency, reliability, and stability of the power network and efficiently manage distributed resources by innovating the generation, supply, and operating system of energy using the power network and the advanced ICT (bidirectional communication, sensor, computing, and S/W).

The smart grid is a very wide and comprehensive concept that different kinds of industries, such as communications, Internet, electrics and electronics, vehicle, and software, are fused with a power industry. Further, the smart grid has not yet been standardized all over the world as well as the nations involved. Therefore, under the leadership of power providers and a government, all the countries of the world have enforced a policy on the smart grid which demands for innovation in the power network and various related fields and requires an enormous investment from a long-term point of view.

To stabilize intermittent output characteristics of new renewable energy sources, such as sunlight and wind power, within a short period of time and overcome a time difference between power generation and demand, it is essential to apply an energy storage system (ESS). The battery balancing is one of the important factors to increase efficiency of the energy storage system.

As illustrated in FIG. 1, the apparatus for battery balancing according to the exemplary embodiment of the present invention includes a plurality of batteries 100, a plurality of power relay assemblies 200, and a manager 300, in which the power relay assemblies 200 are connected to each other in parallel. In other words, one power relay assembly 200 is connected to one battery 100 in series and the connection between the batteries 100 are made by connecting between the power relay assemblies 200 in parallel.

The battery 100 includes a positive terminal 110 and a negative terminal 120 and is configured in plural. In this case, the battery 100 may be charged by being supplied with power from the outside or may deliver the charged power to a load. In this case, the power supplied from the outside may be power, household power (220V), industrial power (380V), and the like which are produced from power plants such as fire power, water power, nuclear power, sunlight, solar heat, wind power, tidal power, and the like.

The battery 100 may be any one selected from a battery unit cell, a battery module, a battery tray, and a battery bank.

The battery module may include a plurality of battery unit cells which include a positive terminal and a negative terminal. In this case, the battery cell units may be connected in series, in parallel, or in a serial and parallel mixing structure.

Further, the battery tray may include a plurality of battery modules. In this case, the battery modules may be connected in series, in parallel, or in a serial and parallel mixing structure.

Further, the battery bank may include a plurality of battery trays. In this case, the battery trays may be connected in series, in parallel, or in a serial and parallel mixing structure.

For example, the plurality of battery trays are connected in parallel and when the balancing between the battery trays is made, the battery tray becomes the battery 100. In this case, the battery modules configuring the battery tray may be connected in any of a serial structure, a parallel structure, or serial and parallel mixing structure.

The power relay assembly 200 includes a precharge resistor 251, a plurality of relays 230, 240, and 252, an input terminal 210, and an output terminal 220 and electrically connects or disconnects between the input terminal 210 and the output terminal 220, in which the input terminal 210 is connected to the positive terminal 110 and the negative terminal 120 of the battery 100 and is configured in plural. In this case, as the precharge resistor 251, a variable resistor may be used. Further, the precharge resistor 251 may have a resistance value which is controlled by the manager 300 and may prevent a large amount of current from flowing (arc discharge).

Herein, if the relay may control an electrical connection between the battery 100 and a balancing output terminal 10, any relay, such as a contact type relay, a contactless type relay, a positive temperature coefficient (PTC) switching device, and a field effect transistor, anything may be used.

In other words, the power relay assembly 200 is connected to the battery 100 in series and is provided to correspond to the battery 100. For example, when 8 batteries 100 are connected in parallel, 8 power relay assemblies are also required to control the battery balancing of each battery 100 Further, among the batteries 100 to be controlled for balancing which are connected in parallel by the operation of the power relay assembly 200 connected to the battery 100 in series, a current of the battery having a high voltage flows in a battery having a low voltage and thus a voltage of the battery having a high voltage is reduced and a voltage of the battery having a low voltage is increased, such that the voltage is balanced, thereby implementing the battery balancing.

As illustrated in FIG. 2, the power relay assembly 200 may be configured to include an input terminal 210, an output terminal 220, a first main relay 230, a second main relay 240, and a precharge unit 250.

The input terminal 210 includes a positive input terminal 211 which is connected to the positive terminal 110 of the battery 100 and a negative input terminal 212 which is connected to the negative terminal 120 of the battery 100.

The output terminal 220 includes a positive output terminal 221 which is connected to the outside and a negative output terminal 222 which is connected to the outside.

The first main relay 230 is connected to the positive terminal 110 of the battery 100 in series and may cut off the current applied from the battery 100.

The second main relay 240 is connected to the negative terminal 120 of the battery 100 in series and may cut off the current applied from the battery 100.

The precharge unit 250 is connected to the first main relay 230 or the second main relay 240 in parallel and includes a precharge resistor 251 and a precharge relay 252, in which the precharge resistor 251 and the precharge relay 252 are connected in series.

The manager 300 is connected to the battery 100 and the power relay assembly 200, respectively, monitors the state of each of the batteries 100, and determines the balancing mode at the time of the occurrence of voltage unbalance in the battery to control the power relay assembly 200.

In other words, the precharge unit 250 is connected to the first main relay 230 or the second main relay 240 to be precharged before a current output from the high voltage battery 100 flows. By this configuration, an arc discharge which may occur when the precharge unit 250 is directly connected to the first main relay 230 or the second main relay 240 is prevented to secure stability of a circuit.

For example, as illustrated in FIG. 2, when the precharge unit 250 is connected to the first main relay in parallel, the precharge unit 250 connects the second main relay and connects the precharge relay 252 by a control of the manager 300 to perform precharging. Next, when the risk of the arc discharge disappears after a predetermined time elapses, the precharge unit 250 connects the first main relay and disconnects the precharge relay 252 by the control of the manager 300 to implement a normal connection therebetween.

FIG. 2 illustrates that the precharge unit 250 is connected to the first main relay 230 in parallel, but in some cases, the precharge unit 250 may be connected to the second main relay 240 in parallel.

Generally, the battery management system 300 is connected to a sensor which is connected to the battery 100 to sense various states of the battery 100, serves to keep the voltage of the battery 100 so as not to drop to a predetermined voltage (discharge final voltage) or less based on the information sensed by the sensor and prevent the battery 100 from being charged at a predetermined voltage or more, and generally manages the battery 100, like monitoring and controlling the charge of state (SOC), voltage, current, temperature, and the like of the battery 100. Generally, the battery management system (BMS) is responsible for these functions and in this case, the battery management system becomes the manager 300.

Since characteristics of each battery are not the same, a voltage difference may occur between the batteries connected in parallel due to the continuous charging and discharging. The battery balancing is very important in the lifespan of the battery. For example, when a lithium ion battery is overcharged, most of the active materials of the lithium ion battery react with other materials and an electrolyte, which may potentially lead to damage to the battery or even the explosion of the battery. Further, when the battery is deep-discharged or continuously discharged, the battery may be circuit-shorted despite a terminal voltage below a specific threshold called a cutoff voltage, such that the battery may be changed to an irreversible condition.

In this case, when the voltage of the battery 100 does not belong to a balance determination range, the manager 300 determines the battery 100 as a battery of which the voltage unbalance occurs. For example, by setting an average or a deviation, such as the battery voltage or the state of charge, to be a determination reference value, a value obtained by adding or subtracting a predetermined error allowable value from the determination reference value is set to be a balance determination range, and thus the battery deviating from the balance determination range may be determined as the battery 100 of which the voltage unbalance occurs.

Further, the balancing mode of the manager 300 may determine the battery to be balanced including some of the batteries in which the voltage unbalance is sensed.

In other words, all the batteries in which the voltage unbalance is sensed are not a balancing object but when there are batteries 100 in which the voltage balancing is sensed, the battery to be balanced is determined. In this case, the battery to be balanced may be classified into a battery to be charged and a battery to be discharged. For example, when the average value of voltages of each battery are set to be the determination reference value, 5 batteries are connected in parallel and when the voltages of each battery are 210V, 220V, 220V, 225V, and 225V and the predetermined error allowable value is 6V, the balance determination range is 214 to 226V, and the number of batteries which does not belong to the balance determination range is one 210V battery. In this case, under the assumption that one 210V battery and two 225V batteries are connected in parallel and there is no consumed current due to a resistor, all the batteries are 220V and thus all batteries are included in the balance determination range. Herein, the battery to be charged becomes a 210 V battery and the battery to be discharged becomes a 225V battery.

Further, the balancing mode of the manager 300 may determine the resistance value of the precharge resistor 251. It is possible to prevent an excessive current from flowing at the time of the battery balancing and control the time required for battery balancing by controlling the resistance value of the precharge resistor 251. In other words, if it is expected that the excessive current flows at the time of the battery balancing, the resistor value of the precharge resistor may be increased, the current value flowing the battery balancing may be reduced, and the resistance value of the precharge resistor may be reduced to shorten the time required for the battery balancing.

As illustrated in FIG. 3, a method for battery balancing according to an exemplary embodiment of the present invention is a method for battery balancing using the apparatus for battery balancing including the battery, the power relay assembly, and the manager and includes monitoring (S10), determining the unbalance (S20), determining the balancing mode (S30), and controlling the balancing (S40).

In the monitoring (S10), the manager monitors voltages of each battery in real time.

In the determining of the unbalance (S20), the manager determines the unbalance of voltages of each battery monitored in the monitoring. In this case, in the determining of the unbalance (S20), when the voltages of the batteries connected in parallel do not belong to the balance determination range, the manager determines the battery as a battery of which the voltage unbalance occurs.

In other words, by setting the average or the deviation, such as the battery voltage or the state of charge, to be the determination reference value, the battery deviating from the value obtained by adding or subtracting the predetermined error allowable value from the determination reference value may be determined as the battery 100 in which the voltage unbalance occurs. Here, the determination reference value may be calculated by monitoring each battery 100 in real time and the error allowable value may be previously determined and used.

For example, when the average value of voltages of each battery is set to be the determination reference value, if the average value of voltages of each battery is 220V and the predetermined error allowable value is 3V, the balance determination range is 217 to 223V. Herein, the deviation is a measure which indicates an error difference of data or an extension of a distribution, and as the deviation, a sum of deviation square, a standard deviation, an average deviation, a quartile deviation, and the like may be used.

In the determining of the balancing mode (S30), the manager determines the balancing mode when the battery determined as the voltage unbalance in the determining of the unbalance occurs. In this case, the determining of the balancing mode (S30) may include determining the balancing object (S31) to determine the battery to be charged and the battery to be discharged in the highest efficiency side by comparing the predetermined references. Further, the determining of the balancing mode (S30) may include determining a resistance value (S32) of the precharge resistor 251 in the highest efficiency side by comparing the predetermined references. Herein, the predetermined reference of the determining of the balancing mode (S30) is at least any one selected from lifespan, output, and time of the battery.

When the batteries are connected in parallel, various methods, such as a method for charging the battery having a low charging state and a method for discharging the battery having a high charging state, to implement the battery balancing may be used. For example, when there are battery A which is charged by 60% and battery B which is charged by 50%, the battery B is charged and thus becomes a battery charged by 60% to be the same as the battery A. Alternatively, when there are the battery A which is charged by 60% and the battery B which is charged by 50%, the battery A is discharged and thus becomes a battery charged by 50% to be the same as the battery B. Even though the method for discharging a battery is not preferred in energy efficiency, the method for discharging a battery is simply performed and thus may be efficiently used in some cases. However, when the battery A which is charged by 60% and the battery B which is charged by 50% are connected in parallel by controlling the power relay assembly, under the assumption that no power lost due to the resistor is present, the battery A and the battery B are the battery which is charged by 55% and therefore are more efficient.

In the controlling of the balancing (S40), the manager controls the power relay assembly depending on the balancing mode determined in the determining of the balancing mode.

In this case, the controlling of the balancing (S40) may include connecting the relay (S41) which connects a precharge relay of the power relay assembly connected to the battery to be charged and the battery to be discharged determined in the determining of the balancing object (S31) to the contact between the first main relay or the second main relay corresponding to the precharge relay. For example, when the precharge unit is connected to the first main relay in parallel, the second main relay is connected to the precharge relay to implement the battery balancing. Alternatively, when the precharge unit is connected to the second main relay in parallel, the first main relay is connected to the precharge relay to implement the battery balancing.

Further, the controlling of the balancing (S40) may include controlling the resistance value (S42) which controls the resistance value of the precharge resistor 251 with the resistance value determined in the determining of the resistance value (S32).

According to the apparatus and the method for battery balancing in accordance with the exemplary embodiments of the present invention, the battery balancing is performed by controlling the power relay assembly when the voltage unbalance between the batteries connected in parallel occurs, thereby preventing the battery from deteriorating to increase the stability of the battery, extending the lifespan of the battery, and saving the maintenance costs of the battery.

The present invention is not limited to the foregoing embodiments, but applications thereof may be various, and may be variously changed without departing from the scope of the present invention.

1. An apparatus for battery balancing, comprising:
a plurality of batteries including positive terminals and negative terminals;
a plurality of power relay assemblies including precharge resistors, a plurality of relays, input terminals, and output terminals and electrically connecting or disconnecting the input terminals to or from the output terminals, the input terminals being connected to the positive terminals and the negative terminals of the batteries; and
a manager connected to each of the batteries and the power relay assemblies, monitoring a state of each of the batteries, and determining a balancing mode at the time of the occurrence of the battery of which the voltage unbalance is sensed to control the power relay assembly,
wherein the output terminals of the power relay assemblies are connected in parallel.

2. The apparatus of claim 1, wherein the power relay assembly includes:
an input terminal including a positive input terminal connected to the positive terminal of the battery and a negative input terminal connected to the negative terminal of the battery;
an output terminal including a positive output terminal connected to the outside and a negative output terminal connected to the outside;
a first main relay connected to the positive terminal of the battery in series and cutting off a current applied from the battery;
a second main relay connected to the negative terminal of the battery in series and cutting off a current applied from the battery; and
a precharge unit connected to the first main relay or the second main relay in parallel and including a precharge resistor and a precharge relay, the precharge resistor and the precharge relay being connected in series.

3. The apparatus of claim 1, wherein the precharge resistor is a variable resistor and a resistance value is controlled by the manager.

4. The apparatus of claim 1, wherein when the voltage of the battery does not belong to a predetermined balance determination range, the manager determines the battery as a battery of which the voltage unbalance occurs.

5. The apparatus of claim 1, wherein the balancing mode of the manager determines a battery to be balanced including some of the batteries of which the voltage unbalance is sensed.

6. The apparatus of claim 1, wherein the balancing mode of the manager determines a resistance value of the precharge resistor.

7. A method for battery balancing using an apparatus for battery balancing including a battery, a power relay assembly, and a manager, the method comprising:
monitoring, by the manager, voltages of each battery in real time;
determining, by the manager, an unbalance of the voltages of each battery monitored in the monitoring;
determining, by the manager, a balancing mode when the battery determined as the voltage unbalance in the determining of the unbalance occurs; and
controlling, by the manager, the power relay assembly depending on the balancing mode determined in the determining of the balancing mode.

8. The method of claim 7, wherein in the determining of the unbalancing, when the voltages of the batteries connected in parallel do not belong to an unbalance determination range, the manager determines the battery as a battery of which the voltage unbalance occurs.

9. The method of claim 7, wherein the determining of the balancing mode includes determining a balancing object determining a battery to be charged and a battery to be discharged in the highest efficiency side by comparing predetermined references.

10. The method of claim 7, wherein the determining of the balancing mode includes determining a resistance value of a precharge resistor in the highest efficiency side by comparing predetermined references.

11. The method of claim 9, wherein the predetermined references in the determining of the balancing mode are selected from any one of lifespan, output, and time of the battery.

12. The method of claim 9, wherein the controlling of the balancing includes connecting a precharge relay of a power relay assembly connected to a battery to be charged and a battery to be discharged determined in the determining of the balancing object to a contact between a first main relay or a second main relay corresponding to the precharge relay.

13. The method of claim 10, wherein the controlling of the balancing includes controlling a resistance value of the precharge resistor with a resistance value determined in the determining of the resistance value.

14. The method of claim 10, wherein the predetermined references in the determining of the balancing mode are selected from any one of lifespan, output, and time of the battery.
